(19) United States
(12) Patent Application Publication
(10) Pub. No.: US 2006/0078393 A1
(43) Pub. Date: Apr. 13, 2006

(54) Cutting improvement structure for a drill

(76) Inventor: Chi-Chin Lin, Daliao Township (TW)

Correspondence Address: RABIN & BERDO, P.C., Suite 500, 1101 14th Street, N.W., Washington, DC, 20005, US

(21) Appl. No.: 11/154,723

(22) Filed: Jun. 17, 2005

(30) Foreign Application Priority Data
Oct. 12, 2004 (TW) 093216133

(51) Int. Cl. B23B 51/02

(52) U.S. Cl. 408/230

(57) ABSTRACT

This invention relates to a drill having hole-drilling alignment precision, and drilling capability, and scrap-release capability. It comprises a drill tip on the cutting part and a drill body with at least two radially reverse screw slots, the drill body comprises an extended clamp part; the drill tip having two more pointed and symmetrical surfaces of pointed, conical, cylindrical shape on the front surface and wedge shape cone on the side surface, the central drilling point on the drill tip of the two symmetrical surfaces forms a point, one side of the symmetrical surface is a cone surface; another side is a scrape surface having an outer side of the front end larger than the drill body, the blade end is installed at the outer side of the scrape surface; a scrap-release slope installed in between the scrape surface and the drill tip to enhance the above mentioned capabilities.

### BACKGROUND OF THE INVENTION

1. Field of the Invention

This invention relates to a cutting improvement structure for a drill, it specifically relates to a drill tip which is modified to be more pointed and a drill point forms a point (instead of a line), this is to improve the drilling characteristics such as: drilling alignment capability, cutting capability and scrap-release capability, etc. of the drill.

2. Description of the Prior Art

The drill in conventional cutting operation is as shown in FIG. 1 and FIG. 2, the drill 10a comprising of a cylindrical cutting part 20a and drill body 30a, the drill body 30a provides a pair of screw slots 40a and a clamp part 50a. This clamp part 50a is for the fixing of the clamp head of the drilling tool. The shape of the cutting part 20a of the drill 10a is normally a cone, its pointed end forms a ridge line 21a, extending from here is a pair of radially reverse blades 22a, the extended part of the blade 22a is further connected to screw slot 40a. In the above-mentioned drill 10a, since the cutting part 20a is of cone shape and the drilling angle is larger than 90 degrees, therefore, a large drilling resistance is created when it drills into the work object and the drilling efficiency is thus low, in addition, the scrap-release design is so bad such that the scrap during the drilling generated by the cutting part 20a of the drill can not be effectively released, it thus remains in the drilling hole which in turn creates more so-called second resistance to the drilling operation; furthermore, since the prior art drill tip which contacts the work object usually forms a ridge line 21a, the ridge line 21a has alignment precision difficulty when it is in contact with work object, this usually causes drilling position error.

### SUMMARY OF THE INVENTION

The main purpose of the current invention is that the drill tip of the cutting part of the drill adopts a side wedge shape cone design in order to reduce the frictional force between the cutting part and the work object, meanwhile, it increases the drilling force of the scrape surface; the blade on the scrape surface is used to drill and scrape away the scrap of the work object; the scrap-release slope beside the scrape surface is used to guide the scrap out of the hole; point shape drill tip is used to perform precise alignment.

### BRIEF DESCRIPTION OF THE DRAWINGS

FIG. 1 is the top view of prior art drill.

FIG. 2 is the front view of FIG. 1.

FIG. 3 is the stereo figure of the current invention.

FIG. 4 is the top view of FIG. 3.

FIG. 5 is the front view of FIG. 3.

FIG. 6 is the side view of FIG. 3.

FIG. 7 shows how the drilling hole releases the scrap in the preferred embodiment of the current invention.

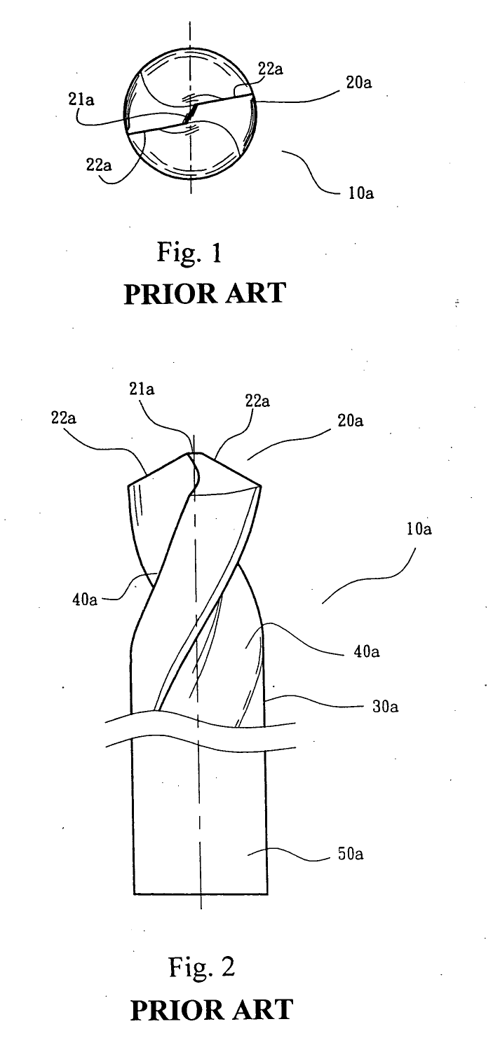

### DETAILED DESCRIPTION OF THE PREFERRED EMBODIMENT

The preferred embodiments of the current invention are described as in the followings accompanied with the drawings.

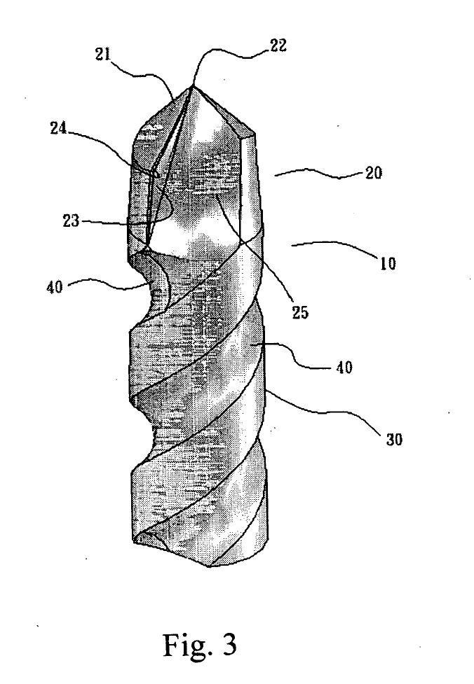

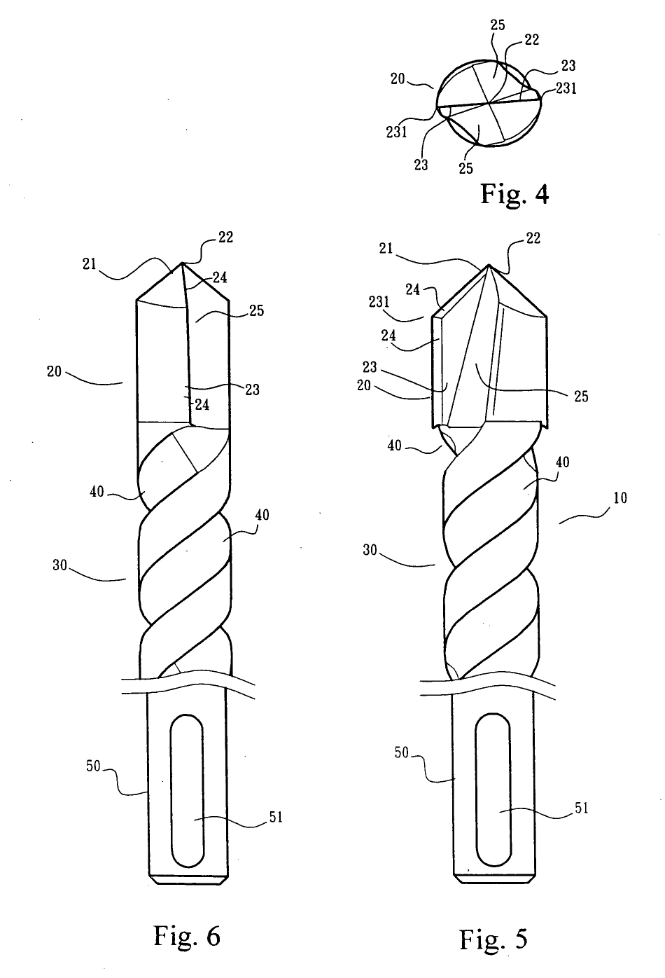

Please refer to FIG. 3, FIG. 4, FIG. 5 and FIG. 6. A drill 10 mainly comprising of a drill tip 21 and a drill body 22, the drill body 22 comprising of an extended clamp part 50 and at least two radially reverse screw slots 40 extending toward clamp part 50 to an appropriate length; at least two symmetrical surfaces, which are less than 90 degrees, having conical and cylindrical shape in the front surface and wedge shape cone in the side surface are installed at the cutting part 20 of the drill tip 21, the center of the drill tip 21 forms a drilling point 22, a non-drilling side of the symmetrical surface is a conical surface; one side of another screw surface of the symmetrical surface is a scrape surface 23 which has an outer side of the front end 231 larger than the drill body 30, meanwhile, blade end 24 is installed at the outer side of the scrape surface 23, the bottom of the scrape surface 23 and the end of the drill body 30 forms a reverse hook; in addition, there is a scrap-release slope 25 installed in between the scrape surface 23 and the drill tip 21, it extends from the drill tip 21 to the bottom of the cutting part 20.

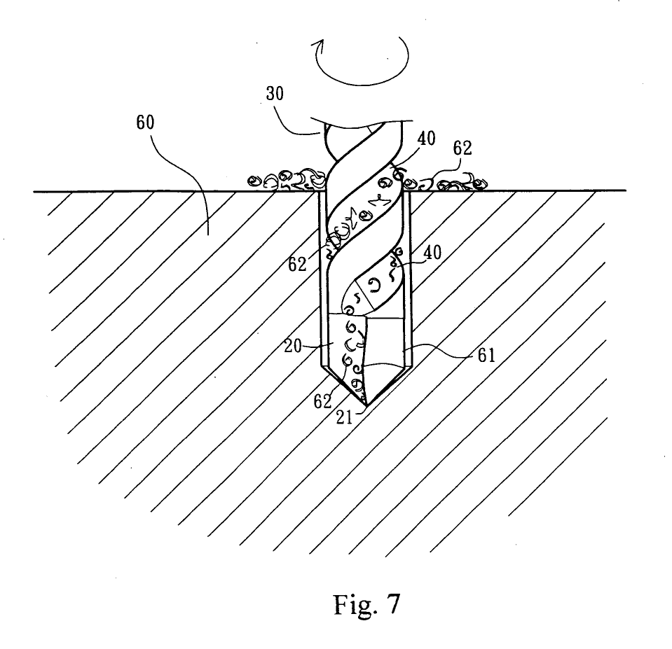

Please refer to FIG. 7, according to the above-mentioned structure, when the drill 10 of the current invention is used to drill work object 60, and the drill tip 21 of the cutting part 20 of the drill 10 forms a drilling point 22, therefore, it can perform precise alignment of drill hole 61 on the work object 60, meanwhile, there is a structural design having a wedge shape cone side surface of the cutting part 20 of the drill tip 21, as well as a design that the outer side of the front end 231 of the scrape surface 23 is larger than the drill body 30, all these designs can let the scrape surface 23 of the front surface have more powerful drilling capability, besides, the blade end 24 installed at the outer edge of the scrape surface 23 can further enhance the drilling efficiency, and the scrap 62 drilled from the work object 60 by the scrape surface 23 can further be guided to the back end of the cutting part 20 by the scrap-release slope 25 beside the scrape surface 23, and finally releases away from the cutting part 20, moreover, it be further released to the surface of the work object 60 by the screw slot 40 of the drill body 30.

We know from the above descriptions, a lot of special designs for the drill 10 of the current invention such as: a more pointed drill tip 21 installed at the cutting part 20, and the pointed conical cylindrical shape at the front surface opposite to wedge cone shape at the side surface, a larger outer side of the front end 231 on the symmetrical surface and a scrape surface with constricted back end, and drill tip 21 forming a drilling point 22, etc., therefore, precise alignment can be achieved for the drilling hole 61, and the work object drilling capability and scrap-release capability can be further enhanced, the conventional drawbacks of too slow in the drilling speed on the work object and the scrap-release difficulty can thus be improved, this invention does fulfill the requirement of a patent. We want to mention that the above descriptions is only one of the preferred embodiment of the current invention, it is not used to limit the practical scope of

What is claimed is:

1. This invention is a cutting improvement structure for a drill, comprising of at least:
a drill tip of a cutting part and a drill body comprising of at least two radially reverse screw slots, the drill body contains an extended clamp; at least two opposite surfaces, smaller than 90 degrees, having pointed conical cylindrical shape on the front surface and wedge shape cone on the side surface are installed at the cutting part of the drill tip, the center of the drilling point of the two opposite surfaces forms a drilling point, one of the non-drilling surface of the opposite surface is a cone surface; one side of another screw surface of the symmetrical surface is a scrape surface which has an outer side of the front end larger than the drill body, meanwhile, blade end is installed at the outer side of the scrape surface, the bottom of the scrape surface and the end of the drill body forms a reverse hook; in addition, there is a scrap-release slope installed in between the scrape surface and the drill tip, it extends from the drill tip to the bottom of the cutting part.

2. The cutting improvement structure of claim 1 wherein the clamp part of the drill body is a non-circular cross section.

3. The cutting improvement structure of claim 1 wherein, the clamp part of the drill body is a slide-preventing tooth.
